(19) United States
(12) Patent Application Publication
(10) Pub. No.: US 2006/0051448 A1
(43) Pub. Date: Mar. 9, 2006

(54) Extruded tubing for mixing reagents

(76) Inventors: Charles Schryver, Atascadero, CA (US); Mason Wages, Adelaida, CA (US)

Correspondence Address: Michael G. Petit, P. O. Box 91929, Santa Barbara, CA, 93190-1929, US

(21) Appl. No.: 10/934,800

(22) Filed: Sep. 3, 2004

(51) Int. Cl. B29C 47/00; B01F 5/06

(52) U.S. Cl. 425/381; 366/337; 366/339

(57) ABSTRACT

An extruded, preferably flexible mixing tube having unitary construction and a lumen coextensive with the length thereof. A mixing portion of the lumen is tortuous and operable for mixing two or more comingled fluids flowing therethrough. The lumen of the mixing tube preferably includes a smooth cylindrical connector portion at both ends thereof dimensioned to receive tubing connectors. The mixing portion of the lumen is disposed between the connector portions and is in fluid communication with the connector portions of the lumens at both ends of the mixing tube. The mixing tube may be extruded in any desired length. The tortuous mixing portion of the lumen may have any desired cross-sectional geometry. In one embodiment the mixing portion is defined by a spiral conduit. In another embodiment, the mixing portion of the lumen varies in internal diameter periodically along the length of the mixing tube. In yet another embodiment, the mixing portion is comprised of a linear sequence of two or more tortuous conduits having different cross-sectional geometries.

### REFERENCE TO RELATED APPLICATIONS

Reference is made herein to copending U.S. patent application Ser. No. 10/778,366, filed Feb. 12, 2004 by the present inventor.

### BACKGROUND OF THE INVENTION

1. Field of the Invention

The present invention relates to a fluid mixing tube and, more particularly, to an extruded tube having a lumen coextensive with the length thereof wherein the lumen includes a mixing portion.

2. Prior Art

The problem of thoroughly mixing two or more fluids is well known in the art and has been addressed by artisans to produce various devices and methods. Prior art mixing devices lack “unitary” construction (i.e., such devices must be assembled from component parts). For example, Kojima, in U.S. Pat. No. 5,605,400, discloses a mixing element comprising a cylindrical pipe through which a liquid flows, and a plurality of blade bodies disposed within the pipe. The blade bodies form a plurality of fluid passages extending spirally and in a longitudinal direction along the pipe. A gap between the blade bodies forms an opening for communicating the fluid passages to each other. The spiral blade bodies are produced independently of the pipe and must be joined to an inner face of the pipe resulting in an article lacking unitary construction.

Walker, in U.S. Pat. No. 4,201,485 discloses an apparatus for continuously mixing liquid resin and powdered hardeners in accurate proportions to produce adhesives. A separable mixing screw and tube lock into a mounting from which they may easily be removed for quick cleanout. The screw has mixing threads that are of the buttress type, having rectangular leading and sloped trailing edges in cross section. The screw is divided into transporting and high shear rate mixing sections. In the transporting section, the rectangular thread edges face in the direction of material flow through the tube. The high shear rate section's buttress threads are modified by spiral cuts in the threads, at a greater lead than the buttress threads. This section is installed with the sloped edge facing the direction of material flow. The apparatus lacks unitary construction and, as a practical matter, can only be made in a finite length

Ainsworth et al., in U.S. Pat. No. 3,591,145, describe a “screw conveyor” type of mixer operable for continuously mixing large amounts of dry clay with linseed oil to make putty. An extrusion stage is required to mix the “plastic” materials. The Ainsworth apparatus is designed to handle large amounts of material. The Ainsworth device would be inoperable for mixing fluids in milliliter quantities. Again, the device lacks unitary construction and the construction and operation of the device impose practical limitations on the length of the mixing path.

When an article is comprised of more than one separable component that have been joined to one another, the article is said to have “integral” construction. Articles having integral construction are generally rigid, are relatively costly to construct and may break at the joining interface. Conversely, articles having unitary construction have no joints and are fabricated in a single piece. An example of unitary articles that have advanced the art are multilumen elastomeric tubing made by extrusion through a die such as disclosed in U.S. Pat. No. 6,394,141 to Wages et al., and U.S. Pat. No. 5,125,913 to Quackenbush. Such unitary multilumen tubing obviates the (prior art) need to bond two or more separable single-lumen tubes to one another by adhesive means to form a single multilumen tube having integral construction.

A mixing tube that relies on the turbulent flow of two or more fluids cointroduced into one end of the mixing tube to affect mixing thereof must provide: (a) means for inducing turbulent flow; and (b) a flow length that is sufficient to assure complete mixing of the fluids prior to ejection from the mixing tube. It is customary to deploy baffles within a flow stream to induce turbulent flow. It is, however, difficult to dispose baffle means within the lumen of a tube. A mixing tube having baffles disposed in a lumen may be made by injection molding, but such mixing tubes are limited in length due to practical limitations on the size of a mold. It is, therefore, desirable to provide a mixing tube that is adapted to receive two or more fluids into a lumen and provide means for inducing turbulent flow of the fluids therethrough. It is further desirable to provide a mixing tube that can be made in any desired length and is preferably flexible such that a substantial length of mixing tube can be looped to save space.

### SUMMARY

The present invention is directed to a mixing tube having unitary construction operable for receiving and mixing two or more fluids as they pass through the mixing tube that substantially obviates one or more of the limitations of the related art. To achieve this and other advantages, and in accordance with the purpose of the invention as embodied and broadly described herein, the invention includes a tube having a length and a lumen coextensive with the length. At least one, and preferably both, of the opposing ends of the lumen of the mixing tube comprise a connector portion that is adapted to receive and engage a tubing connector. A mixing portion of the lumen disposed between the connector portions is operable for inducing and maintaining turbulent flow of one or more fluids passing therethrough. It is an important feature of the mixing tube made in accordance with the present invention that it has unitary construction and, unlike a molded article, the present mixing tube can be practically made in any desired length by extrusion.

The features of the invention believed to be novel are set forth with particularity in the appended claims. However the invention itself, both as to organization and method of operation, together with further objects and advantages thereof may be best understood by reference to the following description taken in conjunction with the accompanying drawings.

### BRIEF DESCRIPTION OF THE DRAWINGS

FIG. 1 is a longitudinal cross-sectional view of a mixing tube having a lumen wherein the inner diameter of the mixing portion varies to create a series of baffles operable for creating turbulence in a fluid flowing therethrough.

FIG. 2 is an end view of the mixing tube of FIG. 1.

FIG. 3 is a perspective, more or less longitudinal view of a mixing tube having a lumen (shown in phantom) wherein the mixing portion of the lumen defines a spiral flow path to create turbulence in a fluid flowing therethrough.

FIG. 4 is a cross-sectional view of the mixing tube of FIG. 3 taken along section line 4-4.

FIG. 5 is a longitudinal perspective view of a mixing tube having a lumen (shown in phantom) wherein the cross-section of the mixing portion is discontinuous along the length, having more than one geometry and being operable for creating turbulence in a fluid flowing therethrough.

FIG. 6 is a front view of an extrusion die operable for extruding a mixing tube having a spiral lumen.

### DESCRIPTION OF THE PREFERRED EMBODIMENTS

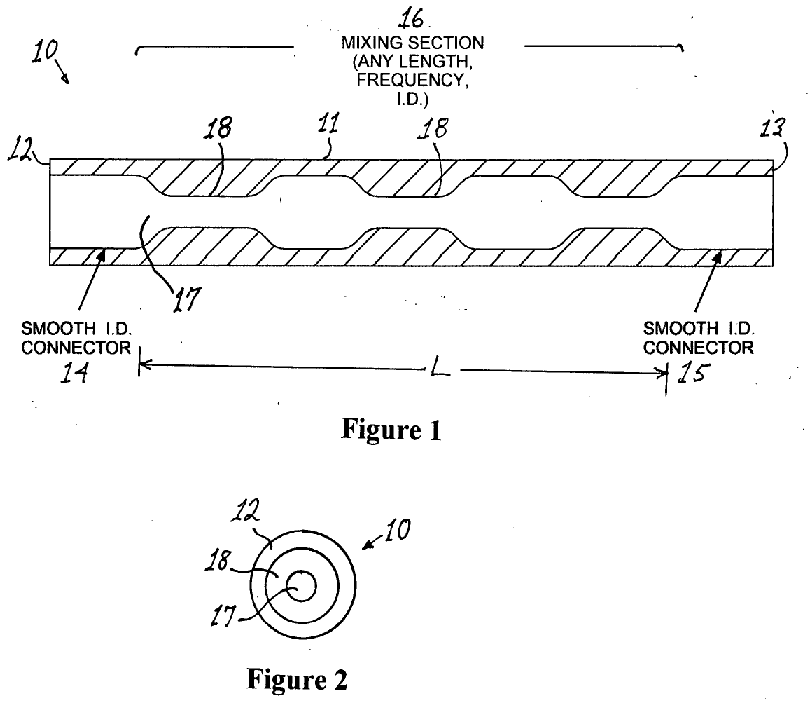

With reference now to FIG. 1, a mixing tube having a body 11, two opposing ends 12 and 13 and a lumen 17 is shown at numeral 10 in longitudinal cross-sectional view wherein the inner diameter of the mixing portion 16 varies sequentially and periodically along the length L of the mixing portion 16 to create a series of baffles 18 operable for creating turbulence in a fluid flowing through the lumen 17. The opposing ends 12 and 13 of the mixing tube 10 have a smooth cylindrical lumen 14 and 15 therewithin that are adapted to be attached to a standard tubing connector or a fluid-conducting manifold (not shown). In practice, two or more fluids are introduced simultaneously, and under pressure, into one end 12 or 13 of the mixing tube 10 as, for example, through a “tee” tubing connector. The velocity of the fluids through the narrow constricted portions of the mixing portion 16 of the lumen is higher than the velocity through the expanded portions (i.e., the portions of the lumen within the mixing portion having the greatest I.D.) of the mixing portion. The alternating changes in velocity create turbulence in the flow path (i.e., within the mixing portion of the lumen) thereby mixing the fluids. An end view of the mixing tube 10 is shown in FIG. 2.

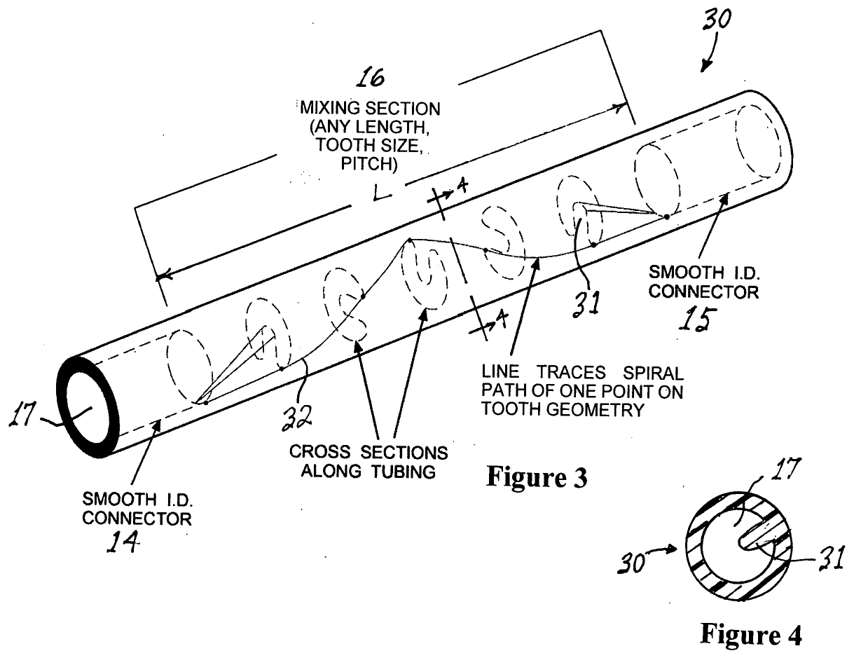

Turning now to FIGS. 3 and 4, another “spiral” embodiment or, in the alternative, “toothed” embodiment of the unitary mixing tube is indicated at numeral 30. In the toothed embodiment of the mixing tube 30, a portion of the lumen wall of central lumen 17 projects inwardly to form a “tooth” that spirals around the inner diameter of the lumen throughout the length L of the mixing portion. A cross-sectional view of the “tooth”, taken along section line 4-4 of FIG. 3, is shown in FIG. 4. The effect of the continuous “tooth” is to create a spiral ridge along the length L of the mixing portion 16. The spiral ridge provides a continuous series of baffles that induce turbulent flow in the mixing portion of the lumen, forcing a fluid or fluids flowing through the mixing portion to flow laterally as well as longitudinally thereby producing sufficient turbulence to affect mixing. The general direction of flow of a fluid through one cycle of the toothed ridge within the mixing portion is indicated at line 32. The flow path 32 is described generally as a spiral. The “tooth” is illustrated at 31 in the cross-sectional view of the mixing portion shown in FIG. 4.

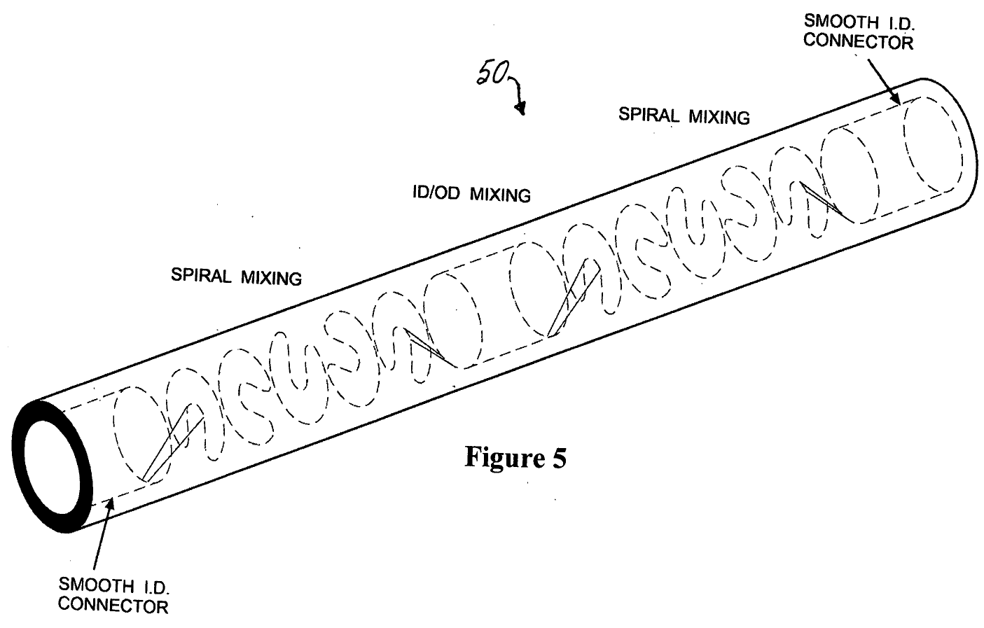

Yet a further hybrid embodiment of a mixing tube is indicated in perspective view at 50 in FIG. 5.

Methods for making an extruded tubing having a variable outer diameter are known in the art. For example, Batdorf, et al., in U.S. Pat. No. 5,511,965, discloses an apparatus for making extruded tubing having one or more lumens therein with a variable outer diameter. The apparatus is useful for forming tubing of an extrudable material such as an elastomer or thermoplastic. The extrudable material is forced around a mandrel disposed within a substantially circular die aperture. Such an apparatus may be used, for example, to make kink-resistant tubing. In one embodiment, the substantially circular aperture in the extrusion die has a diameter that varies periodically during the extrusion while the mandrel remains constant. The mandrel, however, can be mounted on the extruder die to be reciprocally moveable. If the diameter of the substantially circular aperture is held constant and a mandrel having a first outer diameter on a distal end thereof and a second outer diameter adjacent to the first outer diameter, is reciprocally moved in the direction of extrusion such that the outer diameter of the mandrel disposed within the circular aperture changes periodically between the first outer diameter and the second outer diameter, a mixing tube in accordance with the first embodiment (i.e., having a periodically varying inner diameter) can be extruded in any desired length.

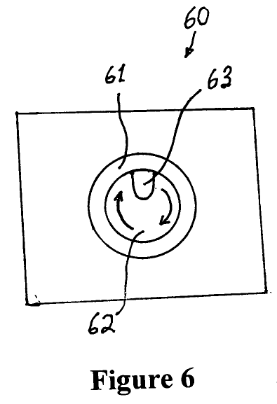

Turning now to FIG. 6, an extruder die 60 is illustrated in front view (i.e. from the direction in which the mixing tube is extruded). If the extruder die 60 comprises a circular aperture 61 and the mandrel 62 has a slot 63 in the distal end thereof (i.e., in the end of the mandrel disposed within the aperture), a tubing can be extruded having a “U-shaped” lumen coextensive with the length thereof in accordance with the cross-sectional view illustrated at 17 in FIG. 4. If, however, the slotted mandrel 62 is rotated within the aperture during extrusion as illustrated by the curved arrows in FIG. 6, the “U-shaped” lumen will form a spiral along the mixing portion 16 of the mixing tube 30 as illustrated in the mixing tube 30 in FIG. 3. A hybrid mixing tube wherein the mixing portion comprises both a spiral lumen portion and a variable I.D. portion can be extruded from an extruder die having a reciprocating, rotatably mounted mandrel disposed within the die aperture. The slot in the mandrel is closed by slot closing means when the mandrel is moved reciprocally to provide a circular lumen having a variable I.D. and opened by slot opening means when the mandrel is rotated to provide a spiral lumen.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What I claim is:

1. An extrusion die comprising a die aperture, a rotationally-mounted slotted mandrel disposed within said die aperture to partially occlude said die aperture and a slotted mandrel rotation means operable for rotating said slotted mandrel during extrusion of an extrudable material through said die aperture.

2. A mixing tube having unitary construction and being operable for mixing two or more fluids, said mixing tube comprising an extruded length of a flexible elastomeric tube having a first end and a second end and a lumen therebetween, said lumen having a mixing portion operable for creating turbulent flow in a fluid flowing therethrough.

3. The mixing tube of claim 2 wherein and said mixing portion of said lumen is a spiral conduit.

4. The mixing tube of claim 2 wherein said mixing portion of said lumen has a plurality of baffles disposed sequentially along a length of said mixing portion, said plurality of baffles formed by changes in the an internal diameter of said mixing portion of said lumen, said baffles being operable for creating turbulent flow in a fluid flowing through said mixing portion.

5. The mixing tube of claim 2 wherein a first portion of said mixing portion is a spiral conduit and a second portion of said mixing portion has a plurality of baffles sequentially disposed in said mixing portion of said lumen.

6.
